(19) United States
(12) Patent Application Publication
(10) Pub. No.: US 2022/0290783 A1
(43) Pub. Date: Sep. 15, 2022

(54) FIRE HOSE WITH REFLECTIVE MARKER

(71) Applicant: Eduardo Feital De Carlo, Mogi das Cruzes (BR)

(72) Inventor: Eduardo Feital De Carlo, Mogi das Cruzes (BR)

(21) Appl. No.: 17/273,073

(22) PCT Filed: Aug. 23, 2019
(86) PCT No.: PCT/BR2019/050353

§ 371 Date: Sep. 28, 2021

(30) Foreign Application Priority Data
Sep. 4, 2018 (BR) BR202018067754-9

(51) Int. Cl. F16L 11/02; A62C 33/00

(52) U.S. Cl. CPC F16L 11/02; A62C 33/00

(57) ABSTRACT

Fire hose composed of single textile reinforcement made entirely from high-strength polyester thread, horizontal weaving (fabric type), in white, and an internal tube made from synthetic rubber, in black, in types I, II and III, and type IV with an external coating made from Special Acrylic Ink in red or special luminescent ink in orange, yellow and pink, and an internal tube made from synthetic rubber, in black, with greater abrasion resistance, in accordance with Standard. NBR 11861 in both types, characterized by the inclusion of arrows in reflective material over the entire length thereof, between 1 and 1.8 meters on the two intercalated faces, further having Connection Seals, in blue, directly at the respective outlet from the fire truck, hydrant or other means used for the entry of water into the hose, and the other connection seal in red for coupling to the nozzle used (Figures A.2 and A.5).

Due to the lack of visibility and staking of the firefighter in confined and low lighting locations for possible emergency evacuation, the proposed innovation has the aim to supply such a need, as it utilizes from the existing fire hose as a beaconing object by means of luminance and mainly by means of reflective arrows inserted therealong, directing the firefighter and or persons that are within the location shown, to the entry site thereof. therefore, providing better evacuation conditions.

DESCRIPTION OF THE DRAWINGS

The amount of views necessary for a good understanding of what has been referenced throughout this document.

Figure A.1—body of a fire hose with photoluminescent pigmentation in yellow, orange and pink colors, and may be used without pigmentation.

Figure A.2—quick connect joint in red color, identifying that it is to be at the leading end, to the spout of the hose.

Figure A.3—is a cross-sectional view of the gun type of the present invention;

Figure A.4—arrows with reflection when exposed to natural or artificial light (use of flashlights).

Figure A.5—Quick connect joint in blue color, identifying that it is to be coupled to the water source (fire pump, hydrator, etc.).

### DETAILED DESCRIPTION OF THE INVENTION

It has been observed over the years and study of occurrences involving firefighters in confined locations and with little visibility, sometimes with toxic gases and high temperatures, the difficulty in evacuation of the location shown when this is needed, in view of the lack of visibility, and the need to follow operating procedures that aim the safety of the firefighter, such as walking always on 4 brackets and the walls of the building, seeking safe evacuation, which substantially increases the evacuation time, which time is sometimes greater than that allowed by the supply of breathable air provided by the respiratory protection equipment, thereby causing, health damage and sometimes the death event to professionals and or persons derived from the hidden building.

It is noted that the use time of a firefighter with the respiratory protection equipment ranges from 25 to 35 minutes of breathable air, the main reason for the staking for a rapid evacuation.

The proposed utility model is the improvement of fire hoses of types 1, 2, 3 and 4, as NBR Standard 11861, which have as elements of their manufacture and composition respectively:

Type 1: fire hose with textile reinforcement sinice made 100% high tenacity polyester, horizontal weave (screen type), white color and inner tube of synthetic rubber, in black color.

Type 2: fire hose with textile reinforcement sinice made 100% high tenacity polyester yarn, horizontal weaving (screen type), white color and inner tube of synthetic rubber, black color, as type 2 of NBR standard 11861.

Type 3: fire hose with double woven textile reinforcement made 100% high tenacity polyester, horizontal weaving, white color, and inner tube of synthetic rubber, black color, enhanced abrasion resistance, as type 3 of NBR Norm 11861.

Type 4: fire hose with textile reinforcement sinice made 100% high tenacity polyester, horizontal weaving (twill type), outer coating in Special acrylic Paint, red color and inner tube of synthetic rubber, black color, with increased abrasion resistance as type 4 of NBR standard 11861.

Such proposed improvement, it is used in the pigmentation in fluorescent material in colors, yellow, orange or pink from textile reinforcement made at 100% polyester (in the hoses of type 1, 2 and 3) and further, in the application of arrows of reflective material to light, throughout its length, respecting the spacing between arrows from 1.2 to 1.8 meters, interleaving these every 0.6 to 0.8 meters on one side and another of the diameter as described in figure A.4.

In the type 4 hose, the florescent pigmentation is made in the special acrylic ink used in making or in the extruded material, in the case of using this manufacturing procedure, as well as the application of the reflective-reflective arrows, meeting the criteria adopted in the previous paragraph.

### Working and Operation of the Equipment:

The operation of the proposed innovation is exactly the same as the use of the current hoses, however, in both the buildings and the vicinity of the firebox, are in the customary rule, and can be this adduct realized by spiral or zig-zag, one of the differences in the use of the proposed innovation is the coupling of its blue color union joint directly to the respective outlet of the fire vehicle., hydraulic or other medium that is used for water input into the hose, and the other red color union joint, should be coupled to the used spout (Figures A.3 and A.5). The photoluminescent pigmentation applied to the hose makes this a constant light object, facilitating its observation at locations where the illumination is pre-existing or non-existent, and the arrows inserted in this, after the light exposure, becomes reflective, beacons the return path, as the arrows have the sense facing the blue color binding joint (Figure A.4), unlike today's hoses, as these in locations of little or no visibility, are not viewed, only tactile, that it makes it difficult to return to the home location in a possible evacuation situation.

### Field of the Invention

Fire hoses have their use in residential and commercial buildings where their use is required by law.

The use of the proposed innovation has its scope in the firefighting and firefighting industries.

### Prior Arts

After searches in the INPI, GOOGLE PATENTS (www.google.con/patents), Espacenet, no products have been found with the features of the proposed innovation, reflective light arrows aliased to photoluminescence.

### Conclusion

By meeting all requirements that define the patent of the invention, it is by combining and modifying known elements, giving them novel and amenable to manufacture, and modifications may be made without departing from the spirit and scope of the present patent and the following claims.

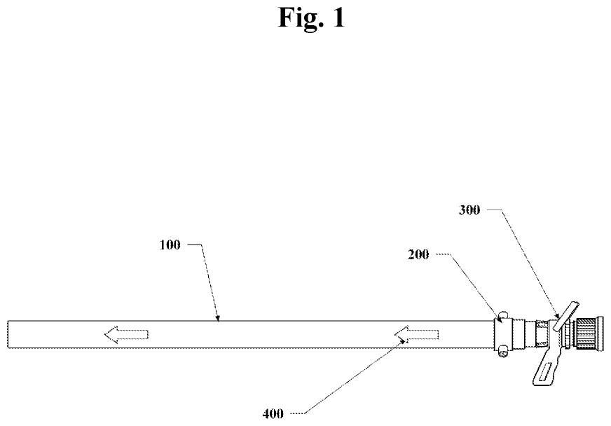

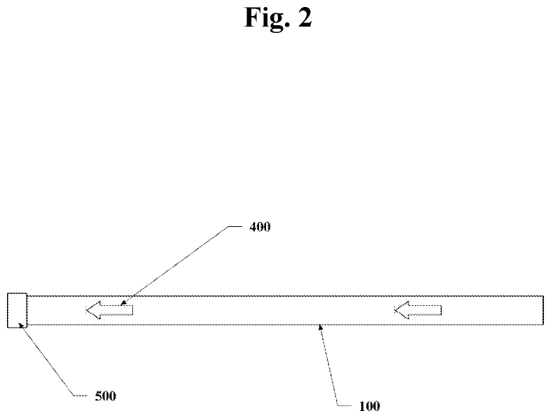

1. Spacer fire hose, (FIGS. 1 and 2) composed by textile reinforcement sinice made 100% in high tenacity polyester yarn, horizontal weaving (screen type), in the white color and inner tube of synthetic rubber, black color, in types I, II and III, as NBR-11861, characterized by inserting arrows of reflective material throughout its length, between 1 to 1.8 meters in the two intermeshed faces (Figure A.4).

2. The fire hose (FIGS. 1 and 2) according to claim 1, characterized by single textile reinforcement made 100% in high tenacity polyester yarn, horizontal weaving (screen type), inner tube of synthetic rubber, black color, type IV with outer coating In special acrylic paint in red color or special luminescent paint in orange, green, pink, and inner tube of synthetic rubber, black color, with a greater resistance to abrasion as type 4 of NBR Standard 11861 characterized by inserting arrows of reflective material throughout its length, the spacing between these should be between 1 to 1.8 meters in the two intermeshed faces (Figure A.4).

3. The joining joints (FIGS. A.3 and A.5) according to claim 1, of blue color directly at the respective outlet of the fire vehicle, hydro or other medium that is used for water input into the hose, and the other red color union joint, should be coupled to the used spout.
